(19) United States
(12) Patent Application Publication
(10) Pub. No.: US 2024/0174065 A9
(43) Pub. Date: May 30, 2024

(54) TONNEAU COVER OPENING AND LOCKING SYSTEM

(71) Applicant: KEKO ACESSÓRIOS S/A, Caxias do Sul (BR)

(72) Inventor: Juliano Scheer MANTOVANI, Caxias do Sul (BR)

(21) Appl. No.: 17/615,483

(22) PCT Filed: May 19, 2021
(86) PCT No.: PCT/BR2021/050210

§ 371 Date: Nov. 30, 2021

(30) Foreign Application Priority Data
May 21, 2020 (BR) 1020200101510

(51) Int. Cl. B60J 7/10; B60J 7/185

(52) U.S. Cl. CPC B60J 7/104; B60J 7/185

(57) ABSTRACT

The tonneau cover opening and locking system, object of the present invention, comprises a profile (10) provided with fastening and fitting components (30), (40), (50) and (80), actuated by rods (70), which contains a compensating mechanism for stretching the tarpaulin and which allows the user to perform the opening movement in an fast, quick and practical way, due to a set of actuators that facilitate user access and allow the easy release of the fixing locks. The system also incorporates solutions that increase the reliability and lifetime of mechanical locking. This new embodiment adds greater practicality to the tonneau cover locking and opening system, ensuring greater efficiency, lifetime, usability and greater flexibility in the opening and closing movement by the user.

### FIELD OF THE INVENTION

The present invention describes a tonneau cover opening and locking system with tarpaulin stretch mechanism. More specifically, it comprises a profile provided with fixing and fitting components activated by rods, which allow the user to perform the opening movement in a fast, quick and practical way due to a set of modular and ergonomic actuators facilitating user access and allowing easy release of fixing latches. The system also has a mechanism provided with springs that keep the tarpaulin always stretched and make the closing smoother and friendlier.

This new embodiment adds greater practicality to the tonneau cover locking and opening system, ensuring greater efficiency, lifetime, reliability and greater flexibility in the opening and closing movement, in addition to ensuring that the tarpaulin is always stretched when closed.

### BACKGROUND OF THE INVENTION

Light cargo vehicles, similar to a pickup truck, with a driver cabin and open bed are suitable for receiving the cover, which may or may not fall back, completely covering the bed.

The tonneau cover consisted of a set of profiles generally forming a rectangle, which will be attached to the vehicle's bed in order to allow the cover to be fixed.

Currently there is a wide variety of covers to cover pickup trucks, closing the bed and leaving it stretched out, so that each model has a fixing and locking system that allows its closing and opening.

Initially, the cover models were equipped with a system of traction straps attached to the vehicle body, which caused several inconveniences to users due to the delay in opening and closing, resulting in a system with low practicality.

Current models describe locking and opening systems equipped with pins that allow easier fixing and unlocking, but current systems have several inconveniences to users due to the difficulty of simultaneous unlocking on both sides and the difficulty of operating with the tailgate open on taller pickup trucks or for people with short stature, due to the central drive position or on both sides simultaneously.

In addition, the embodiment and fitting way of the pins allow the system to malfunction and premature component wear, which results in difficulty opening and closing and even spontaneous unlocking and, consequently, the cover opening during the vehicle movement. Current systems do not have a tarpaulin compensation and stretching mechanism, which causes tarpaulin expansions and contractions to interfere with the system's operation.

Thus, the present inventor seeking to solve the inconveniences of the market developed an easy-to-use system that allows for greater convenience in locking and unlocking the cover, in addition to compensating for thermal expansion and ensuring perfect stretching of the tarpaulin through an embodiment that ensures greater efficiency and flexibility in the opening and closing movement, modularity in the drive system and durability of the system components. The modular drive system allows to position two or more actuators in one same profile, resulting in a greater possibility of combinations, which allows to serve a wide variety of trucks in the national and international market.

In search performed in the prior art, several documents were identified describing locking systems applied to tonneau covers, wherein it can be highlighted the following document:

BRMU8103687-6, of the same owner, describes a locking system for tonneau covers aiming to lock the rear cover closing in an fast, safe and practical way, as well as unlocking, with a single touch, both sides simultaneously.

U.S. Ser. No. 10/471,815 (Tonneau Cover, 2017) which describes an set having a latch in communication with the plate, the latch having a finger that is adapted to engage the cover stopper and a shaft that is connected to the plate at one end, and the other end the shaft has a pin that is adapted to engage a defined slot in the latch. Removing force from the plate causes the plate to move in the third direction, which causes the latch to move in the fourth direction, so the cover is moved to an open configuration.

CN208393072 (Xu Enli, 2018) describes a cover locking structure of the recovery compartment, which is equipped with a horizontal structure between the trunnion frame fixed with the carriage, connects through the connection seat between the trunnion frame and the horizontal frame. This locking structure can change the compartment cover switch, improving the disassembly efficiency in a flexible way. The different amendment products can also adjust the degree of elasticity above the compartment cover leather.

These prior art documents describe a cover locking and opening system provided with an embodiment having a large number of components which generates several inconveniences for users, resulting in problems with closing and opening the device.

US20180297457 (Truxedo, 2017), CN206954085 (Ningbo, 2017), CN203752989 (Changzhou, 2014), and U.S. Pat. No. 9,067,481 (Cixi City, 2012) describe locking and opening systems applied in tonneau covers so that each document describes and shows an unique embodiment of activation and fixation, so that the subject matter claimed in these documents does not describe a system activated by rods and a system provided with a mechanism with springs always leaving the tarpaulin stretched and making the closing smoother and friendlier.

Therefore, the present inventor seeking to solve the inconveniences of the prior art developed a new embodiment applied to the locking system of tonneau covers, improving the previous system, in order to improve the efficiency in the assembly of the profiles, the cover locking and unlocking system and further improve the operating and increase the durability and reliability of the locking system. Thus, improving the fixing way between the profiles, the fitting system, release of the locking system and tarpaulin compensation and stretching system when compared to the mechanisms currently used in the market. In addition, the system has several innovations that reduce the number of fasteners and components, which reduces the product assembly process.

Thus, the object of the present invention is an opening and locking system of tonneau cover that describes a profile equipped with fixing and fitting components actuated by rods, which may contain a compensating mechanism for stretching the tarpaulin and allowing the user to perform the opening movement in a fast, quick and practical way due to a set of actuators that facilitate the user's access and allow the easy release of the fixation locks. The system also incorporates solutions that increase the reliability and durability of mechanical locking. This new embodiment adds greater practicality to the tonneau cover locking and opening system, ensuring greater efficiency, lifetime, usability and greater flexibility in the opening and closing movement by the user.

### SUMMARY OF THE INVENTION

Due to the drawbacks identified in the prior art, an opening and locking system with the following characteristics is the object of the present invention:

It is characteristic of the present invention a tonneau cover opening and locking system providing a profile that allows the easy fixing of the locking structures along the ends and the fixing and movement of the actuators.

It is characteristic of the present invention a tonneau cover opening and locking system providing actuators endowed by an unique embodiment that allows its arrangement close to the profile and fixing of the actuation rods of the system.

It is characteristic of the present invention a tonneau cover opening and locking system that provides locking structures arranged along the ends of the profile, which have a unique embodiment that allows easy fixing and arrangement of spacings that allow the fitting of a second structure allowing locking and unlocking of the assembly.

It is characteristic of the present invention a tonneau cover opening and locking system that provides a terminal connected to the side profiles that allows positioning of the second locking structure.

It is characteristic of the present invention a tonneau cover opening and locking system that provides an embodiment improving the tarpaulin stretch.

It is characteristic of the present invention a tonneau cover opening and locking system providing a system of profiles equipped with fastening and fitting components activated by rods, which allow the user to perform the opening movement in a fast, quick and practical way.

It is characteristic of the present invention a tonneau cover opening and locking system providing a set of modular and ergonomic actuators that facilitate user access and allow easy release of the opening locks.

It is characteristic of the present invention a tonneau cover opening and locking system providing a mechanism equipped with springs that keep the tarpaulin always stretched and makes smoother and more friendly the closing.

It is characteristic of the present invention a tonneau cover opening and locking system providing an embodiment that adds more practicality to the tonneau cover locking and opening system, ensuring greater efficiency, lifetime, reliability and greater agility in the opening and closing movement.

It is characteristic of the present invention a tonneau cover opening and locking system providing an embodiment that ensures that the tarpaulin is always stretched when closed.

### BRIEF DESCRIPTION OF THE FIGURES

FIG. 1 shows a perspective view of the opening and locking system.

FIG. 2 shows the profile view detailing its embodiment.

FIG. 3 shows the top view of the profile detailing its embodiment.

FIG. 4 shows the profile view detailing the plastic profiles and the arrangement of the tarpaulin, highlighting the stitching.

FIG. 5 presents the perspective view of the actuator detailing its embodiment.

FIG. 6 shows the top view of the actuator detailing its embodiment.

FIG. 7 shows the view of the profile provided by the plastic profiles and with the arrangement of the actuator, detailing the way of fixing and fitting.

FIG. 8 presents the perspective view of the locking structure, detailing its embodiment.

FIG. 9 shows the lower perspective view of the locking structure, detailing its embodiment.

FIG. 10 shows the top view of the locking structure, detailing its embodiment.

FIG. 11 shows the bottom view of the locking structure, detailing its embodiment.

FIG. 12 shows the perspective view of the locking structure with the attachment of the movement structure, detailing its embodiment.

FIG. 13 shows the top view of the locking structure with the attachment of the movement structure, detailing its embodiment.

FIG. 14 shows the side view of the locking structure with the fixing of the movement structure, detailing its embodiment and pin fixation to the oblong hole.

FIG. 15 shows the exploded view of the locking structure provided by the movement structure and latch pin, detailing the embodiment.

FIG. 16 shows a perspective view of the auxiliary part attached to the lower portion of the locking structure.

FIG. 17 shows the top view of the auxiliary part attached to the lower portion of the locking structure.

FIG. 18 shows the sectional view of the auxiliary part, detailing the fixation design.

FIG. 19 shows the bottom view of the auxiliary part attached to the lower portion of the locking structure.

FIG. 20 shows the perspective view of the movement structure attached to the locking structure, detailing its embodiment.

FIG. 21 shows the lateral perspective view of the movement structure attached to the locking structure, detailing its embodiment.

FIG. 22 shows the top view of the movement structure attached to the locking structure, detailing its embodiment.

FIG. 23 shows the side view of the movement structure attached to the locking structure, detailing its embodiment.

FIG. 24 shows the opposite side view of the movement structure fixed with the locking structure, detailing its embodiment.

FIG. 25 shows the perspective view of the latch pin attached to the movement structure, detailing its embodiment.

FIG. 26 shows the bottom perspective view of the latch pin attached to the movement structure, detailing its embodiment.

FIG. 27 shows the top view of the latch pin attached to the movement structure, detailing its embodiment.

FIG. 28 presents the bottom view of the latch pin attached to the movement structure, detailing its embodiment.

FIG. 29 shows the perspective view of the receiving terminal of the locking assembly arranged along the side profile, detailing its embodiment.

FIG. 30 shows the top view of the receiving terminal of the locking assembly arranged along the side profile, detailing its embodiment.

FIG. 31 shows the bottom perspective view of the locking assembly receiving terminal, detailing its embodiment.

FIG. 32 shows the side profile view detailing its embodiment and the EVA arrangement in the lower portion.

FIG. 33 shows the top view of the locking structure provided by the movement structure, latch pin and auxiliary part, detailing the positioning of the internal components and drive of the assembly.

FIG. 34 shows the bottom view of the locking structure provided by the movement structure, latch pin and auxiliary part, detailing the positioning of the internal to components and drive of the assembly.

FIG. 35 shows the perspective view of the movement structure with the latch pin fitted, detailing its embodiment and fixing way between the structures.

FIG. 36 shows the top view of the opening and locking system, detailing the arrangement of the rods and actuation way.

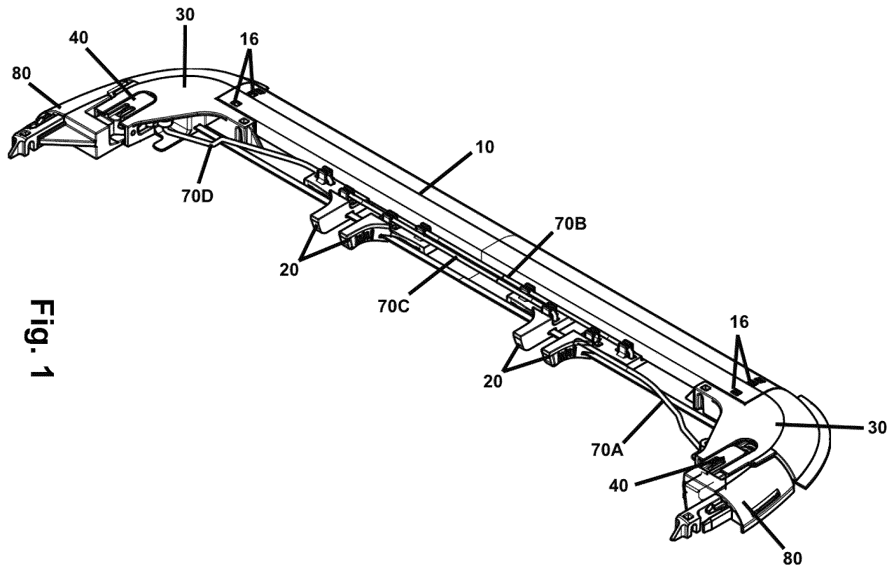

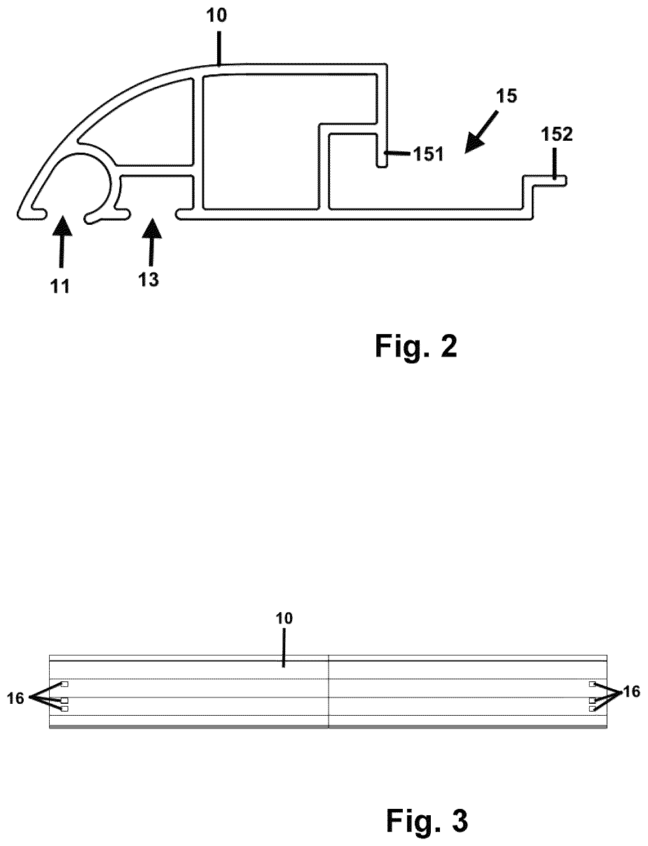

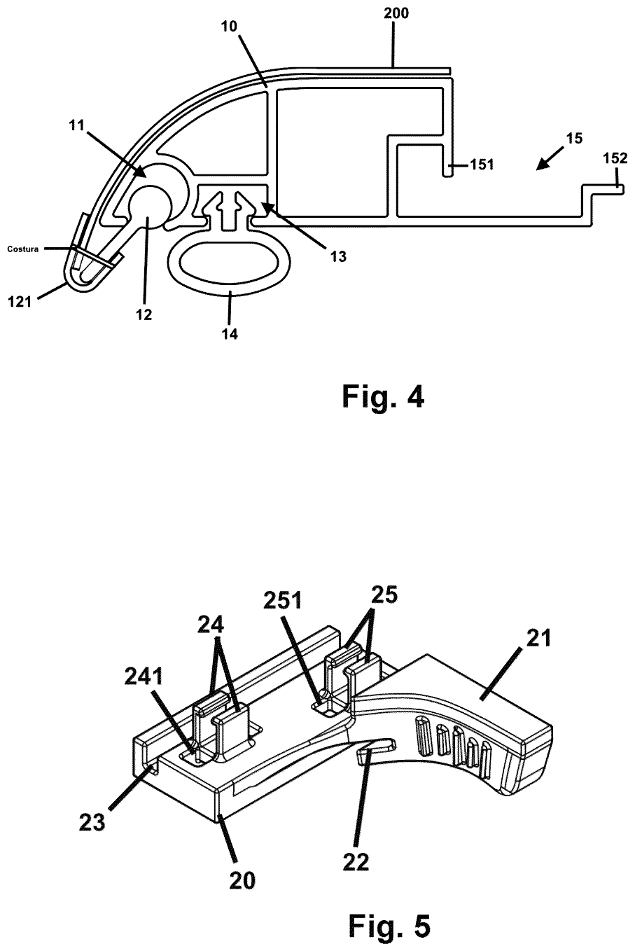

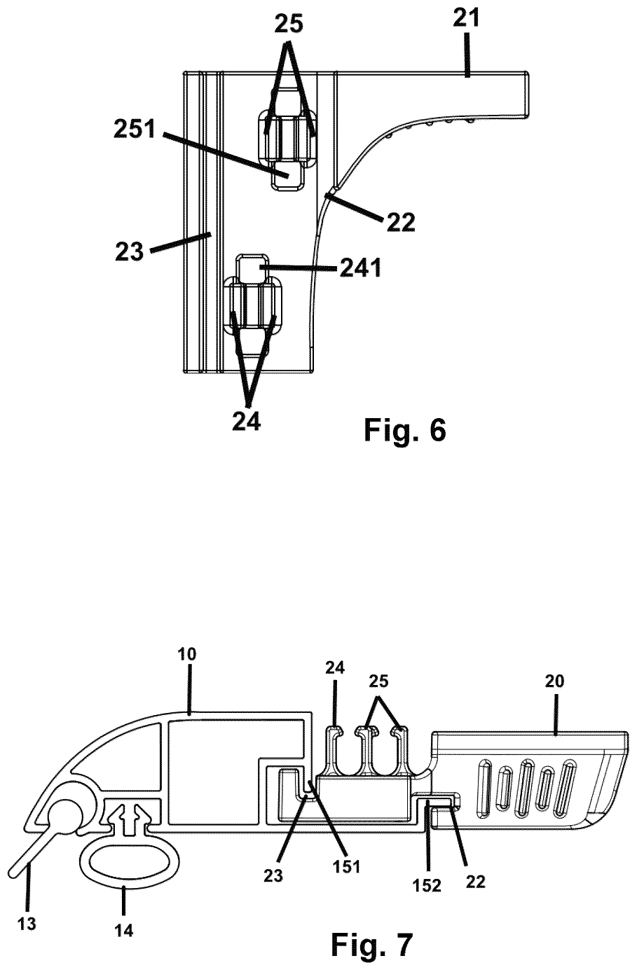

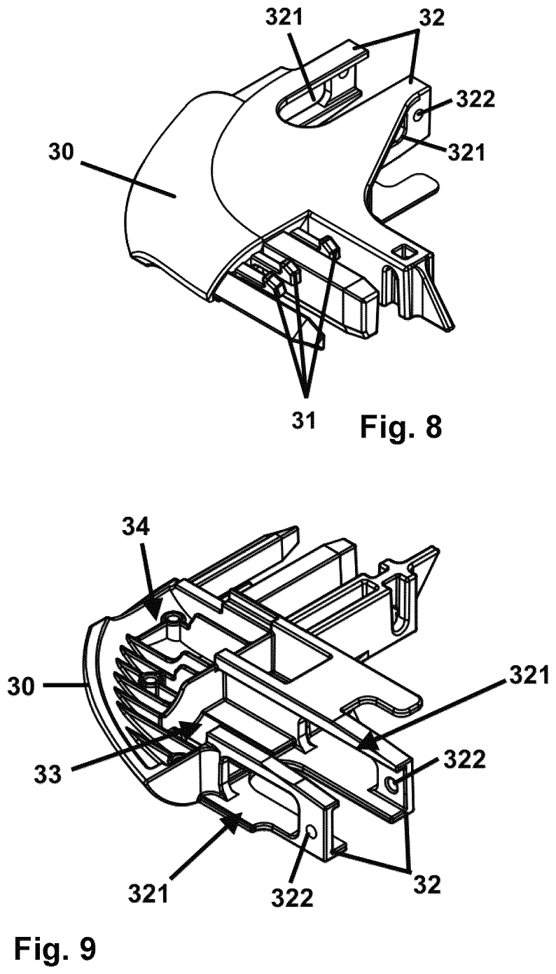

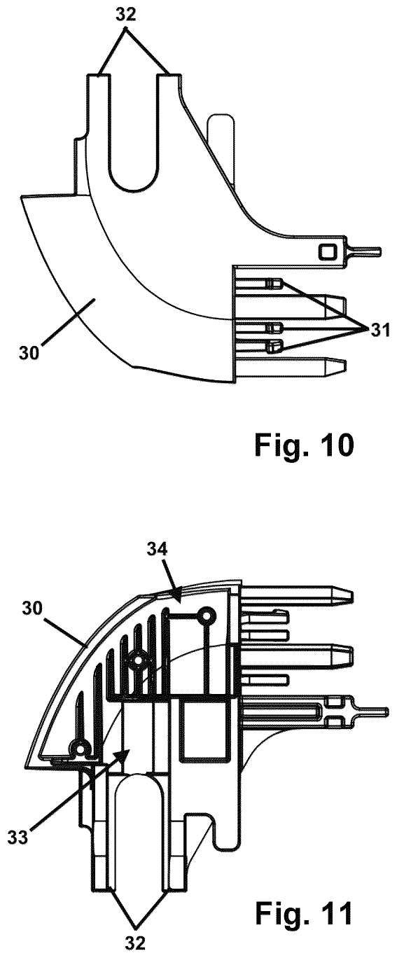

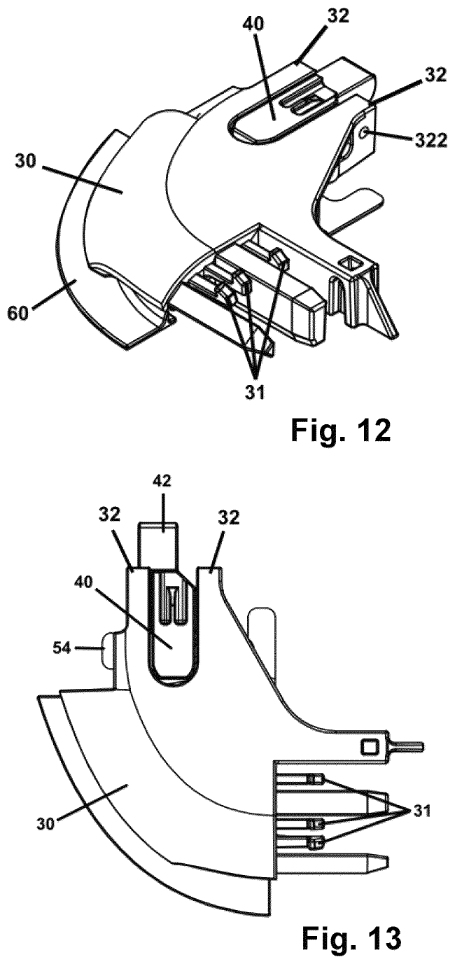

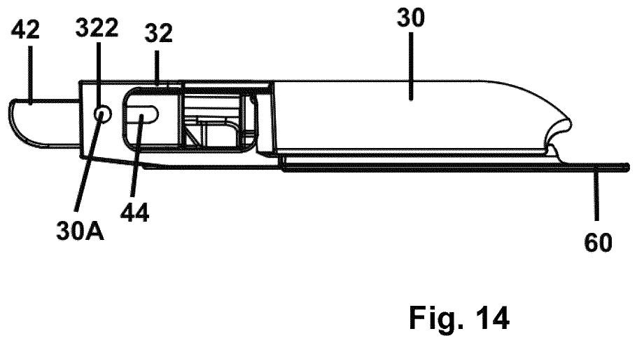

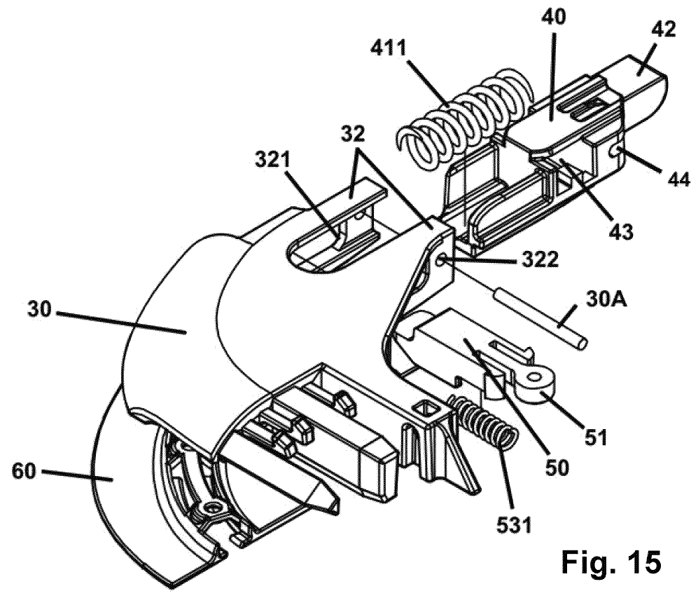

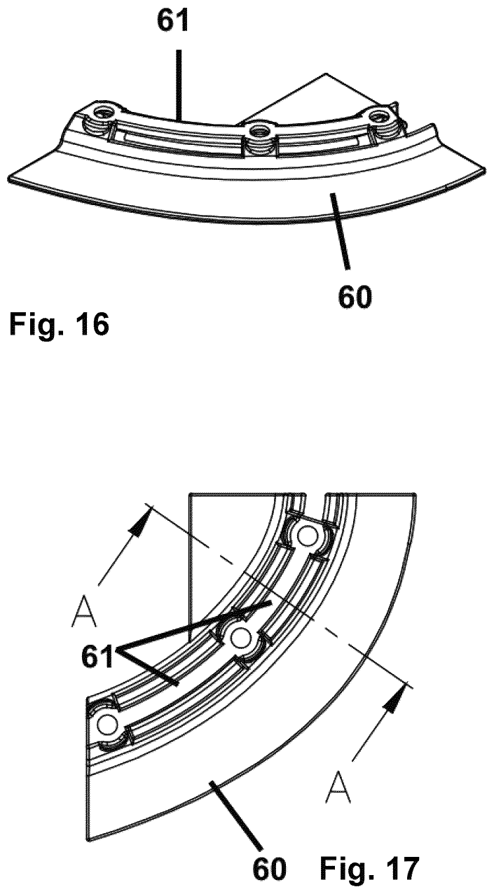

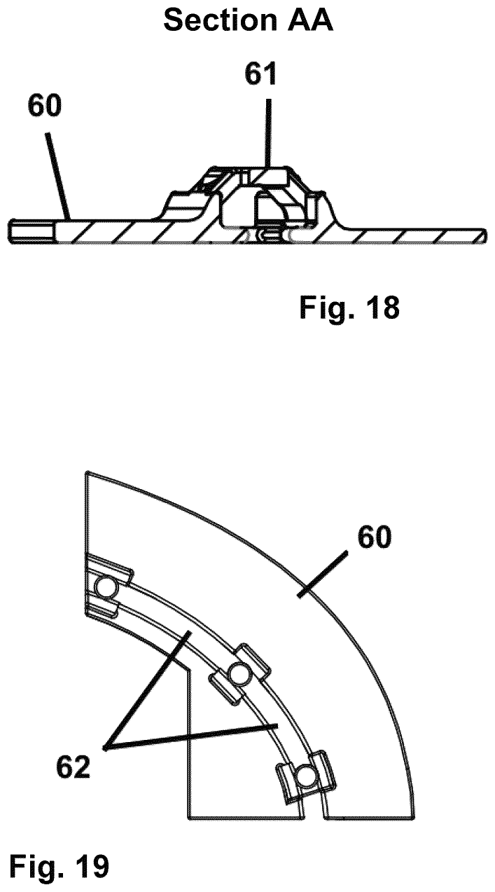

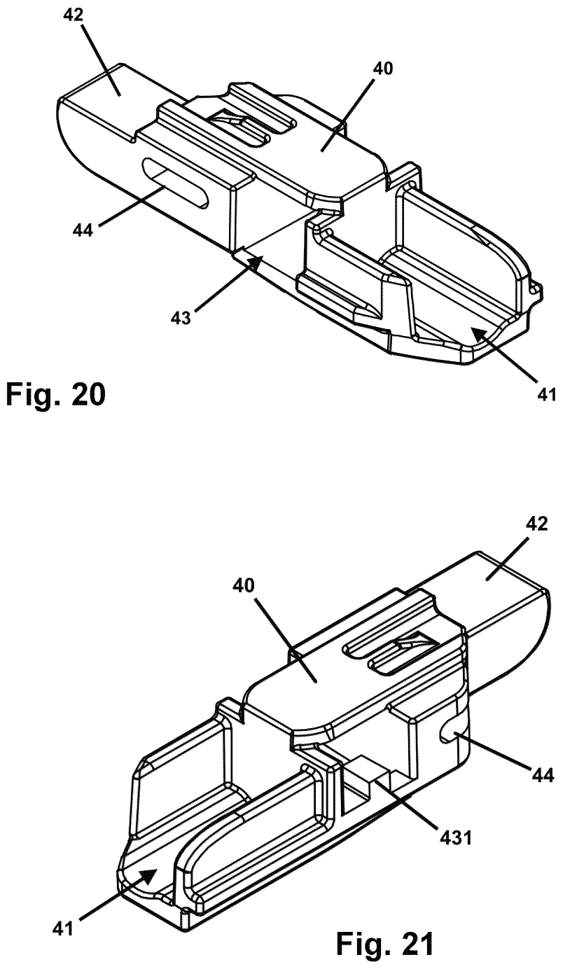

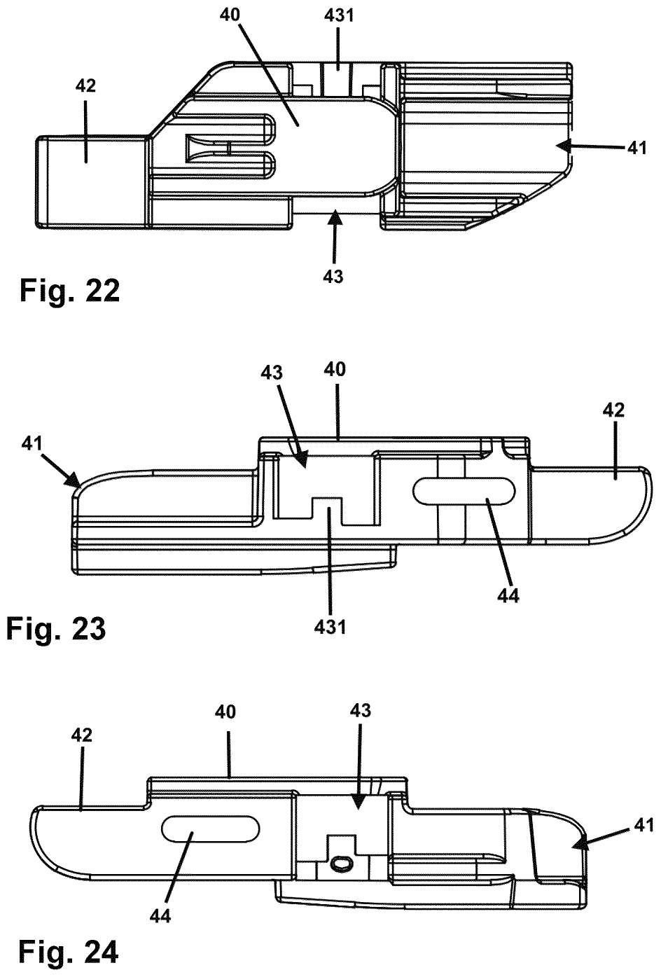

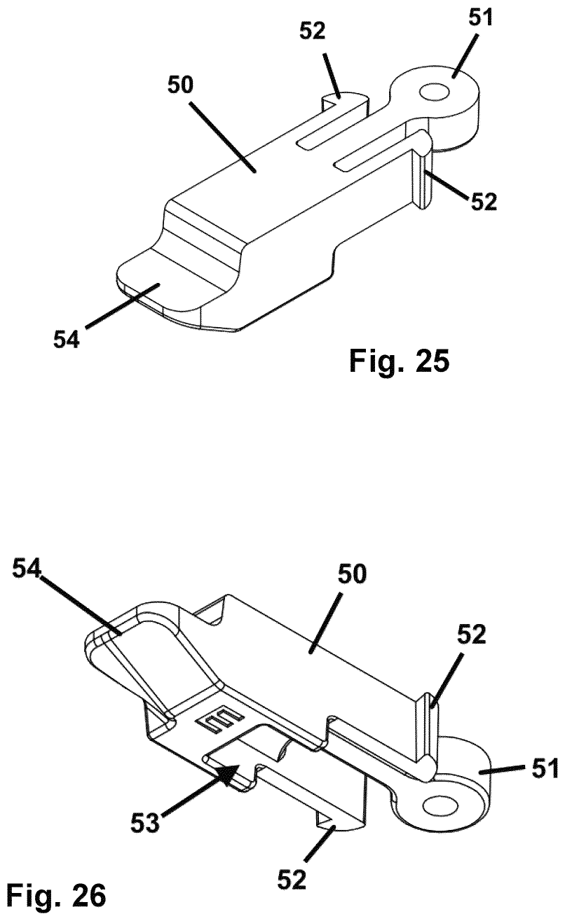

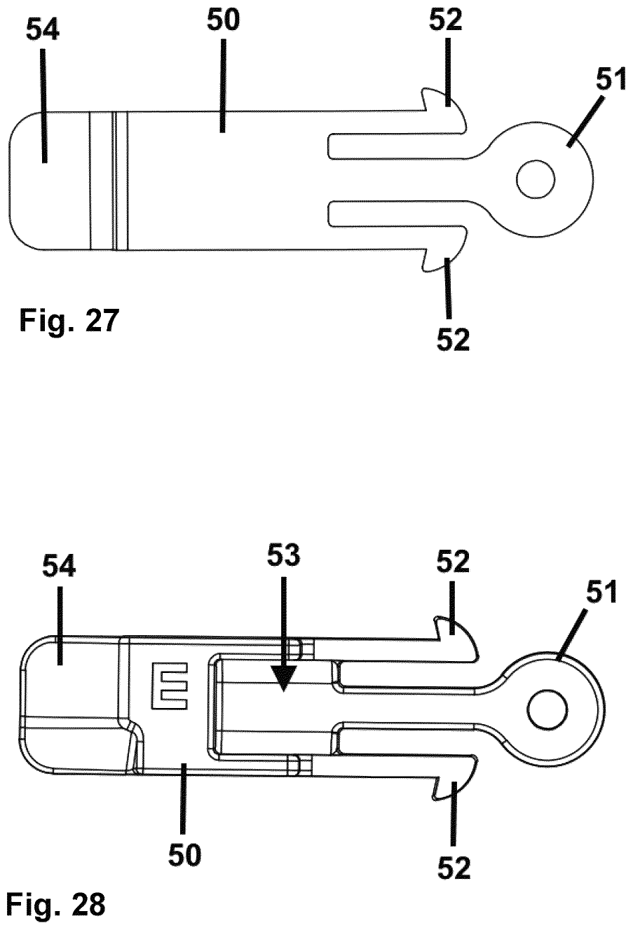

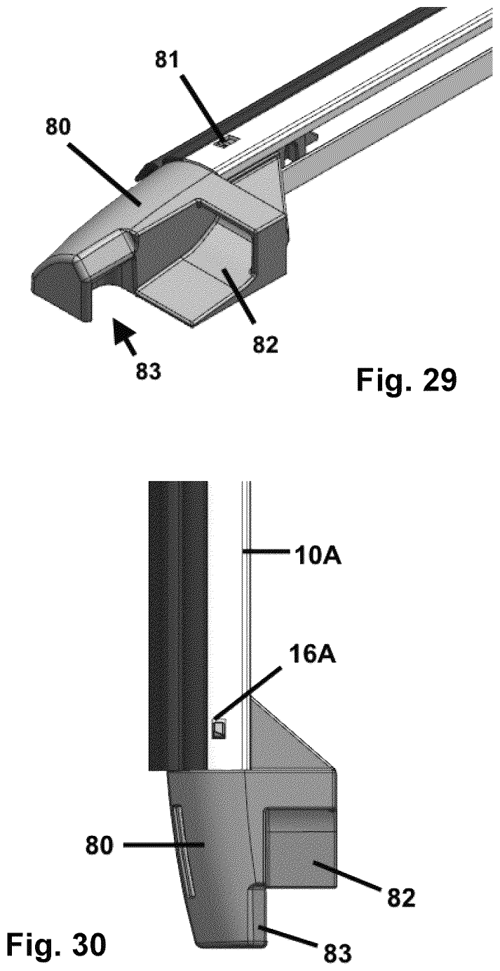

### DESCRIPTION OF THE INVENTION

The tonneau cover opening and locking system, object of the present invention, comprises a profile (10) provided with a set of actuators (20) and locking structures (30) arranged at the ends of the profile and fixed by projections (31) to the holes (16), with the set of profile (10) and structures (30) being connected to the terminals (80) of the side profiles, which allows for easy opening and closing of the cover.

The profile (10) has a lower spacing (11) wherein the tarpaulin will be fitted through a plastic profile (12) sewn on the tarpaulin and a cavity (13) for arranging a second sealing profile (14). In the posterior portion, the profile has spacing (15) provided by projections (151) and (152) that allow the fitting and displacement of the actuators (20).

The profile (12) is fitted laterally in the spacing (11) of the profile (10) allowing the tarpaulin to be fixed to the structure. The fixation of the profile (12) to the tarpaulin (200) occurs by sewing so that an edging (121) is used, arranged on the edge of the tarpaulin with the profile (12), ensuring greater resistance to the seam and preventing the mesh from falling apart.

The profile (14) is fitted in the spacing (13) of the profile (10) upwardly, ensuring greater sealing at the time of closing.

The pair of actuators (20) is formed by two symmetrical parts and describes a projection (21) provided with a groove (22) that allows the fitting with the projection (152) and a groove (23) that fits with the projection (151) of the profile (10), said projection (21) having an ergonomic shape for the positioning of the user's fingers. The actuators (20) have projections (24) provided with holes (241) and projections (25) provided with holes (251), said projections (24) and (25) allowing the fixing and positioning of the system actuation rods.

The actuators (20) are fitted laterally along the profile (10) and tracked through the projections (151) and (152) positioned with the grooves (22) and (23), as shown in FIG. 7.

Locking structures (30) are fitted to the ends of the profile (10) provided with projections (31) that allow the fitting with the profile (10) through a click, so that the projections (31) are provided with a matching tooth that fit with the holes (16) arranged in the profile, facilitating the fixing and fitting system between the structures.

The locking structure (30) is endowed with projections (32) spaced apart from each other that allow the positioning and movement of the structure (40) by fitting and fixing the locking assembly, said projections (32) having a rectangular-shaped opening (321) for the positioning and displacement of the drive pin (50).

The structure (30) is provided in its lower portion by a relief (33) that allows the movement of the structure (40) and a relief (34) that accommodates the auxiliary part (60) for fixing the tarpaulin and arrangement of the sealing profile (14).

The auxiliary part (60) is provided with a projection (61) that fits together with the relief (34) of the structure (30) in order to allow its fixation using screws (not shown). The part (60) is sewn to the tarpaulin and when fixed allows the locking, and between the tarpaulin and the part (60) will be the part (30), and in addition the part (60) is provided with grooves (62) that allow the fitting of the sealing profile (14).

The structure (40) is provided with a bas-relief (41) that allows the positioning of the spring (411) that keeps the system tensioned and at the opposite end describes a projection (42) that allows the fitting of the structure to the terminal (80) which is fitted to the side profile, in order to allow the locking. In the central portion of the structure (40) an opening (43) is arranged that allows the positioning of the latch pin (50), said opening (43) having a projection (431) for positioning the spring. The frame (40) is fitted to the frame (30) by sliding between the projections (32) and next to the relief (33).

The structure (40) is also provided with an oblong hole (44) arranged between the projection (42) and the opening (43), which receives the locking pin (30A).

The latch pin (50) describes a projection (51) for fixing and fitting the drive rods (70) and projections (52) that allow the locking and fitting with the opening (43) of the structure (40). In the lower portion there is a bas-relief (53) for the positioning of the spring (531). At the opposite end, it describes a projection (54) that allows the locking of the structure to the terminal (80) next to the spacing (83).

The operating system of the locking structures (30) occurs through the positioning of the structure (40) between the projections (32) so that the opening (43) is positioned close to the rectangular opening (321) for the placement of the latch pin (50) next to the hole (43), positioning the metal pin (30A) in the hole (322) located in the rods (32) and matching with the hole (322) of the part (30) and the oblong (44) of the part (40), preventing the system from dismantling, in addition to limiting the movement of the part (40) that moves slidingly with the pin (30A).

Thus, the pin (30A) is what guarantees the locking of the structure (40) with the structure (30), so that the pin (30A) serves as a limiter to the movement of the structure (40).

The spring (411) allows the tensioning of the structure (40) with the structure (30) in order to move the profile (10) away from the terminal (80) and, consequently, from the rectangular structure of the cover, which allows to keep the tarpaulin always stretched. When the latch pin (50) is activated, it presses the spring (531) to the projection (431) so that the pin (50) is released from the terminal (80), releasing the cover locking system.

The locking structures (30) are connected to the terminals (80) of the cover side profiles, said structures (80) having projections (81) that allow the fitting with the side profile (10A) through a click, so that the projections (81) are provided with teeth that fit with holes (16A) arranged in the profile, facilitating the fixing and fitting system between the structures.

The frames (80) are provided with a spacing (82) for positioning the projection (42) of the frame (40) and a spacing (83) for positioning the projection (54) of the latch pin (50).

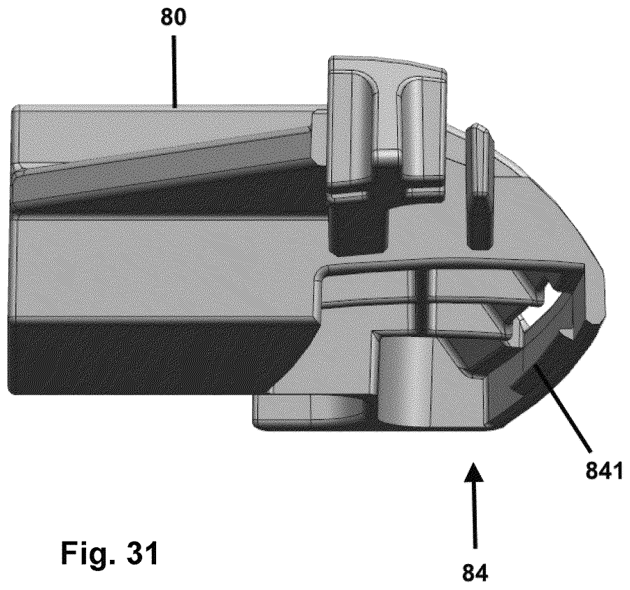

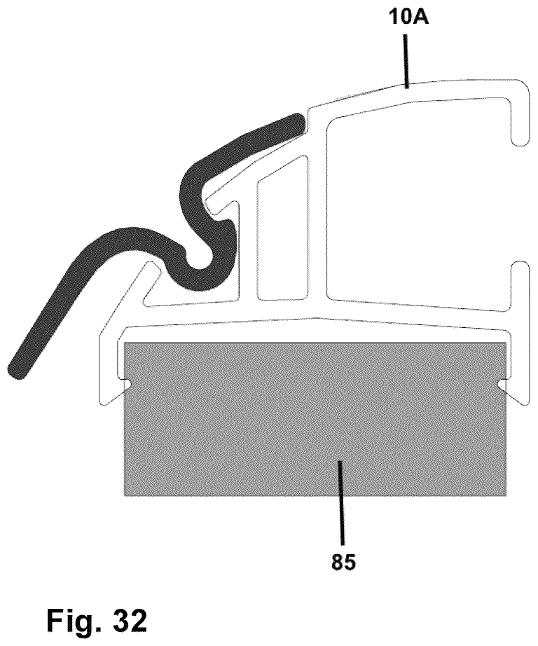

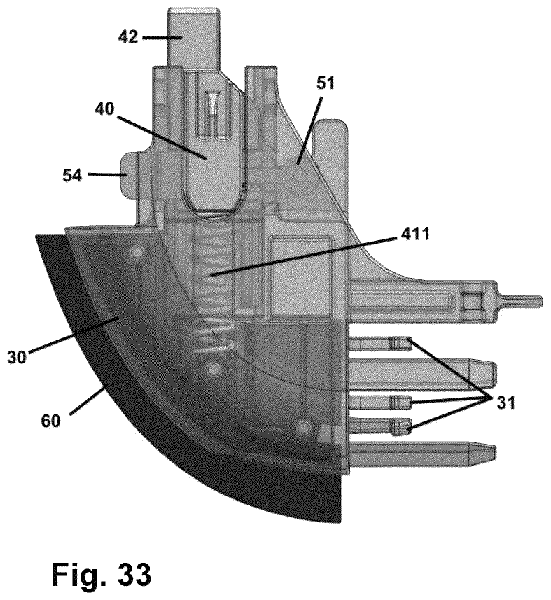

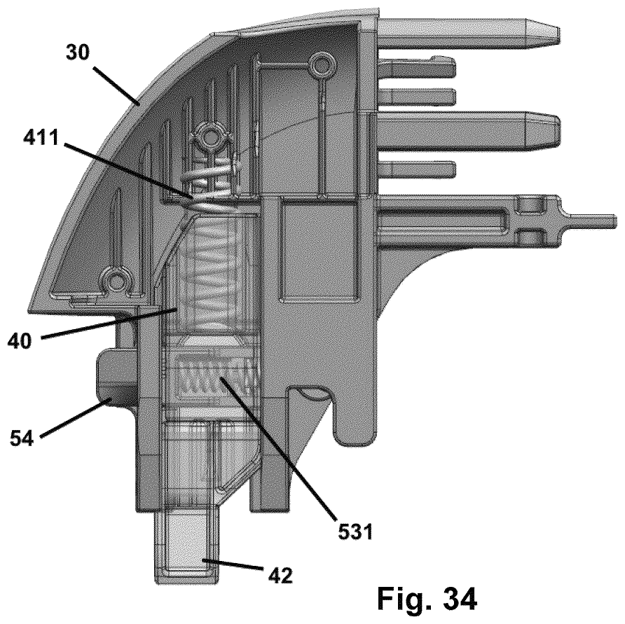

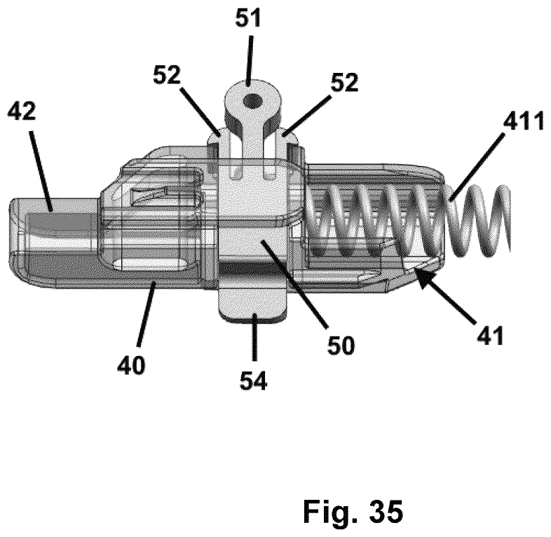

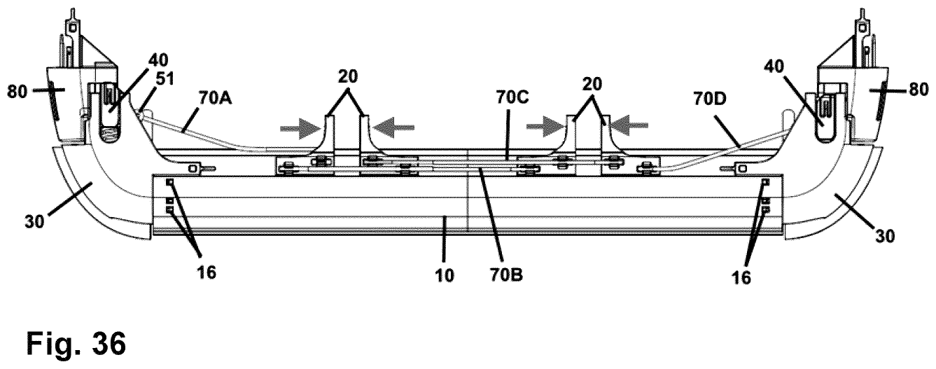

In the lower portion, the structures (80) have a spacing (84) for the positioning of an EVA part (85), said spacing (84) having a tooth (841) that allows fitting and fixing the part (85). The EVA part (85) is fitted together with the structure (80) and side profile (10A), as shown in FIGS. 30, 31 and 32.

The actuation system between the structures (30) connected to the profile (10) and the structures (80) connected to the side profiles (10A) occurs through the actuation of the actuators (20) by the user, so that with the fingers, thumb and indicator, under the profile (10), will make the drive performing the movement against the two parts (20).

The actuators (20) are positioned in pairs in the central portion of the profile (10), so that the total release of the system can take place by the actuation of only one pair of actuators (20) or by the simultaneous actuation of both pairs of actuators. This drive system is only possible due to the form of interconnection between the actuators (20), sets of rods (70) and pins (50).

Actuators (20) are modular, which allows them to be applied and adapted according to the need for using the cover model, allowing for greater variability in the system's implementation. Furthermore, the actuators (20) can be positioned one at each end, being able to be actuated by both hands in the case of a low-cost version.

The rod fixation system (70), as shown in the images, is performed by positioning the rod (70A) to the pin (50), arranged in the left portion, and connected to the first actuator (20) so that the rod (70A) is positioned with the projections (25) and fixed together with the detail (251). The rod (70B) is positioned on the projections (24) of and fixed to the detail (241) of the first, in the second the rod (70B) will be fitted only to the projection (24) and in the third actuator (20) the rod will be fitted to the projection (24) and also in detail (241). The rod (70C) is positioned on the projections (25) of the second, third and fourth actuator (20) so that the rod (70C) functions in a manner similar to the rod (70B). The rod (70D) is positioned on the projections (24) and also on the detail (241) of the fourth actuator (20) up to the pin (50), arranged in the right portion, of the profile (10).

The actuator system (20), as shown in the images, will have four rods (70A), (70B), (70C) and (70D) with two rods being connected to the pins (50) and the other two connected between the actuators (20) which allows the transmission of movement.

The rods (70A), (70B), (70C) and (70D) are fixed with the projection (24) and holes (241) that allow the locking the ends of each rod and projection (25), and holes (251) that allow locking the ends of each rod, so that the end of the rod is bent along the holes.

On the other hand, the actuation system by actuators (20) and rods has a modular characteristic, as it allows the use of one (1) or more actuators (20) in the same profile (10), according to the application needed and type of cover that is being used, allowing the opening way to be varied with one or two hands depending on the distance between the parts (20).

1. A tonneau cover opening and locking system characterized in that it describes a profile (10) provided with a lower spacing (11) wherein a plastic profile (12) sewn on the tarpaulin will be fitted, a cavity (13) for arranging a second sealing profile (14), a spacing (15) provided for engagement and displacement projections (151) and (152) of the actuators (20) and engagement holes (16) of the locking structures; the actuators (20) describing a projection (21) provided with a groove (22) that allows fitting together with the projection (152) and a groove (23) that fits together with the projection (151) of the profile (10), said projection (21) having an ergonomic shape for positioning the user's fingers, said actuators (20) have projections (24) provided with holes (241) and projections (25) provided with holes (251) and are laterally fitted together to the profile (10) and treaded through the projections (151) and (152) positioned along the grooves (22) and (23); the locking structure (30) is provided with projections (32) spaced apart from each other that allow the positioning of the structure (40) for fitting and fixing the locking assembly, said projections (32) having a rectangular shaped opening (321) for the positioning and displacement of the drive pin (50), said structure (30) which is provided in its lower portion by a relief (33) allowing the movement of the structure (40) and a relief (34) accommodating the auxiliary part (60) for fixing the tarpaulin and arrangement of the sealing profile (14), said auxiliary part (60) which is provided with a projection (61) that fits together with the relief (34) of the structure (30) so to allow its fixation through screws, and the tarpaulin is sewn; the structure (40) is provided with a bas-relief (41) allowing the positioning of the spring (411) that keeps the system tensioned and at the opposite end describes a projection (42) that allows the fitting of the structure together with the terminal (80) which is fitted to the side profile, and in the central portion of the structure (40) there is an opening (43) which allows the positioning of the latch pin (50), said opening (43) having a projection (431) for positioning the spring; the structure (40) is fitted to the structure (30) sliding between the projections (32) and next to the relief (33), and the structure (40) is also provided with an oblong hole (44), arranged between the projection (42) and opening (43) which receives the locking pin (30A); the latch pin (50) describes a projection (51) for fixing and fitting the drive rods (70) and projections (52) that allow the locking and fitting with the opening (43) of the structure (40) and in the lower portion it has a bas-relief (53) for positioning the spring (531), at the opposite end describes a projection (54) that allows the locking of the structure to the terminal (80) with the spacing (83); the actuator system (20) is provided with four rods (70A), (70B), (70C) and (70D) with two being connected to the pins (50) and the other two connected between the actuators (20) which allows the motion transmission, said rods (70A), (70B), (70C) and (70D) are fixed together with the projection (24) and holes (241) allowing the locking each rod ends and projection (25) and holes (251) allowing the locking of each rod ends, so that the rod end is bent with the holes; the terminals (80) are provided with a spacing (82) for positioning the projection (42) of the structure (40), a spacing (83) for positioning the projection (54) of the latch pin (50), a spacing (84) for positioning of an EVA part (85), said spacing (84) having a tooth (841) that allows the fitting and fixation of the part (85), and the EVA part (85) is fitted together with the structure (80) and side profile (10A).

2. The tonneau cover opening and locking system according to claim 1, characterized in that the profile (12) is laterally fitted in the spacing (11) of the profile (10) allowing the tarpaulin to be fixed to the structure, and the fixation of the profile (12) to the tarpaulin (200) occurs by sewing so that an edging (121) is used, arranged on the tarpaulin edge with the profile (12).

3. The tonneau cover opening and locking system according to claim 1, characterized in that the profile (14) is fitted in the spacing (13) of the profile (10) upwardly.

4. The tonneau cover opening and locking system according to claim 1, characterized in that between the tarpaulin and the piece (60) is the piece (30) and that the piece (60) is provided with grooves (62) that allow the fitting of the sealing profile (14).

5. The tonneau cover opening and locking system according to claim 1, characterized in that the locking structure (30) occurs through positioning of the structure (40) between the projections (32) so that the opening (43) is positioned along rectangular opening (321) for placing the latch pin (50) with the hole (43), positioning the metal pin (30A) in the hole (322) located at the rods (32) and that match the hole (322) of the piece (30) and the oblong (44) of the piece (40) preventing the system from disassembling and limiting the movement of the piece (40) that moves in a sliding manner along the pin (30A).

6. The tonneau cover opening and locking system according to claim 1, characterized in that the pin (30A) is what guarantees the locking of the structure (40) with the structure (30), so that the pin (30A) serves as a limit to the movement of the structure (40).

7. The tonneau cover opening and locking system according to claim 1, characterized in that the spring (411) allows the tensioning of the structure (40) with the structure (30) in order to move the profile (10) away from the terminal (80) and the rectangular structure of the cover, which allows the tarpaulin to be always stretched out.

8. The tonneau cover opening and locking system according to claim 1, characterized in that the latch pin (50) when activated presses the spring (531) next to the projection (431) so that the pin (50) is released from the terminal (80) releasing the cover locking system.

9. The tonneau cover opening and locking system according to claim 1, characterized in that the projections (81) are provided with a tooth that fit together with holes (16A) arranged in the profile.

10. The tonneau cover opening and locking system according to claim 1, characterized in that the actuation system of the actuators (20) by the user is performed with the fingers, thumb and index fingers, under the profile (10), performing the assembly movement between the two pieces (20).

11. The tonneau cover opening and locking system according to claim 1, characterized in that the actuators (20) are positioned in pairs in the central portion of the profile (10), so that the total system release can occur by actuation of only one pair of actuators (20) or by the simultaneous activation of both pairs of actuators.

12. The tonneau cover opening and locking system according to claim 1, characterized in that the actuators (20) are modular and can be positioned one at each end and can be activated by both hands.

13. The tonneau cover opening and locking system according to claim 1, characterized in that the actuation system by actuators (20) and rods has a modular characteristic, allowing the use of one (1) or more actuators (20) in a same profile (10), allowing the opening shape to be varied with one or two hands depending on the distance between the pieces (20).
